(19) United States
(12) Patent Application Publication
(10) Pub. No.: US 2011/0245991 A1
(43) Pub. Date: Oct. 6, 2011

(54) Fan Speed Duplication

(76) Inventors: William Fred Keown, JR., Raleigh, NC (US); Albert Vincent Makley, Morrisville, NC (US); William Fred Martin-Otto, Apex, NC (US); Marc Richard Pamley, Durham, NC (US)

(21) Appl. No.: 12/749,864

(22) Filed: Mar. 30, 2010

(51) Int. Cl. G05D 23/19; G06F 9/24

(52) U.S. Cl. 700/300; 713/2

(57) ABSTRACT

A computer system retrieves a performance value that corresponds to a first fan's performance, which is controlled by a first fan controller. Next, the computer system generates a control setting based upon the retrieved performance value. In turn, a second fan controller controls a second fan based upon the generated control setting. In one embodiment, the first fan controller is an automatic fan controller and the second fan controller is a manual fan controller.

### TECHNICAL FIELD

The present disclosure relates to duplicating fan speed in a computer system that utilizes multiple fans for cooling the computer system's internal components.

### BACKGROUND

Computer fans are cooling devices for hardware that reside within a computer system. By supplying cool air and removing warm air from the computer system, computer fans allow the computer system to run faster and prevent the computer system from overheating. Computer systems may include automatic fan controllers for controlling the speed at which fans rotate based upon environmental parameters at various locations within the computer system (e.g., temperature values). With the development of more powerful computer system components such as graphic cards and processors, the requirement for effective cooling techniques increases. As such, today's computer systems typically include multiple fans to adequately cool internal components.

### SUMMARY

A computer system retrieves a performance value that corresponds to a first fan's performance, which is controlled by a first fan controller. Next, the computer system generates a control setting based upon the retrieved performance value. In turn, a second fan controller controls a second fan based upon the generated control setting.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE DRAWINGS

The present disclosure may be better understood, and its numerous objects, features, and advantages made apparent to those skilled in the art by referencing the accompanying drawings, wherein:

FIG. 1 shows an embodiment of a computer system manually controlling a fan based upon a different fan's performance values;

FIG. 2 is shows an embodiment of a computer system utilizing multiple cooling fans;

FIG. 3 shows steps taken in an embodiment of a computer system managing automatic fan controllers and manual fan controllers;

FIG. 4 shows embodiments of automatic controller registers and manual controller registers that are included in an input/output controller; and

FIG. 5 shows an embodiment of an information handling system, which is a simplified example of a computer system capable of performing the computing operations described herein.

### DETAILED DESCRIPTION

Certain specific details are set forth in the following description and figures to provide a thorough understanding of various embodiments of the disclosure. Certain well-known details often associated with computing and software technology are not set forth in the following disclosure, however, to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure. Instead, the following is intended to provide a detailed description of one or more examples of the disclosure and should not be taken to be limiting of the disclosure itself. Rather, any number of variations may fall within the scope of the disclosure, which is defined by the claims that follow the description.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

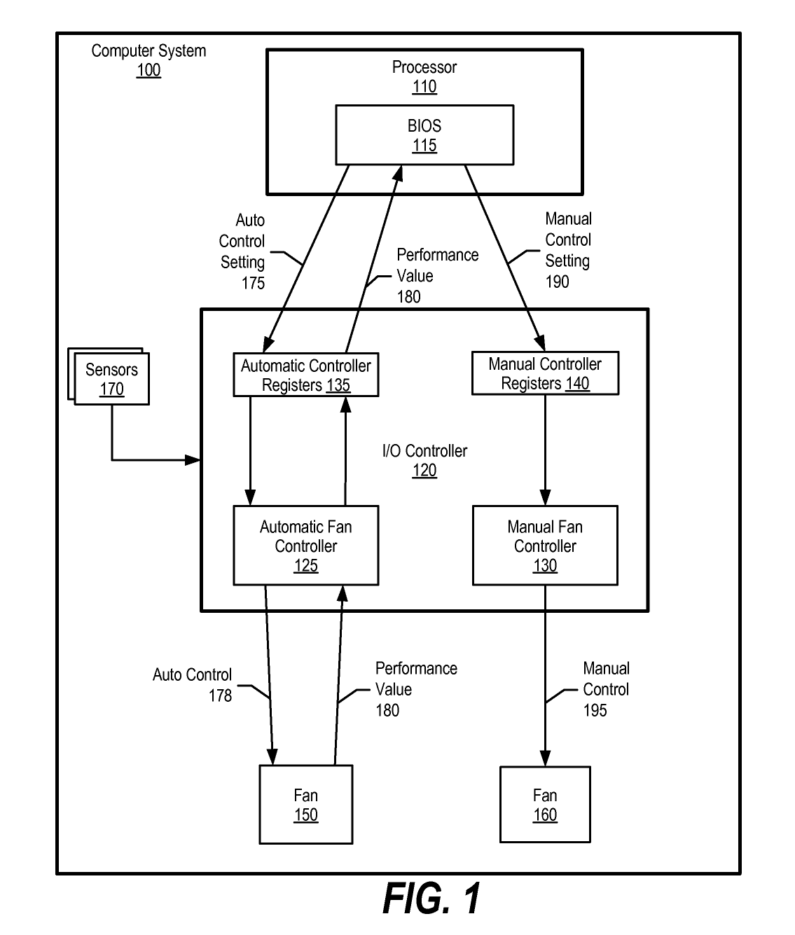

FIG. 1 is a diagram showing an embodiment of a computer system manually controlling a fan based upon an automatically controlled fan's performance values. Computer system 100 (e.g., personal computer, server, router, switch, and etcetera) may require a particular number of cooling fans based upon environmental conditions and the amount of heat generated by devices that reside within computer system 100. Situations arise when computer system 100 requires more fans than it has automatic fan controllers. In these situations, computer system 100 utilizes performance value 180 (e.g., fan speed) from an automatically controlled fan to generate fan speed values for a manual controller (manual fan controller 130) that controls a different fan (fan 160).

Computer system 100 includes processor 110 with BIOS (Basic input/output system) 115. When BIOS 115 commences, BIOS 115 programs input/output controller 120, which entails loading automatic control settings 175 into automatic controller registers 135. Automatic control settings 175 provide operational information as to how automatic fan controller 125 should control fan 150, such as a duty cycle setting or fan RPM (revolutions per minute) target. Automatic fan controller 125 monitors inputs from sensors 170 in order to adequately manage fan 150's speed via automatic control 178, such as changing the pulse width modulation (PWM) duty cycle or tachometer value. For example, sensors 170 may provide a temperature reading for a particular device (e.g., processor 110) and, in this example, automatic fan controller 125 turns on fan 150 at a particular temperature, thus cooling processor 110.

As those skilled in the art can appreciate, a BIOS may be a set of routines stored in read-only memory that enable a computer to start an operating system and to communicate with the various devices in a system, such as disk drives, keyboard, monitor, printer, and communications ports. In one embodiment, functions performed by BIOS 115 may also be performed by other higher level software application programs. In another embodiment, BIOS 115 may be a Unified Extensible Firmware Interface (UEFI), which assists in control handoff of a computer system to an operating system during a pre-boot environment (e.g., after the computer system is powered on, but before the operating system starts).

As automatic fan controller 125 controls fan 150 in real-time, automatic fan controller 125 also receives, or detects, fan 150's performance (performance value 180). For example, performance value 180 may be a pulse width modulation (PWM) duty cycle, a tachometer value, or a voltage value. Automatic fan controller 125 stores performance value 180 in automatic controller registers 135 for later retrieval by BIOS 115 (discussed below).

At particular intervals, such as once per second, BIOS 115 retrieves performance value 180 from automatic controller registers 135, and generates manual control setting 190 from performance value 180. In one embodiment, BIOS 115 copies performance value 180 as manual control setting 190 (e.g., 400 revolutions per minute). In another embodiment, BIOS 115 may utilize an algorithm to generate manual control settings 190 from performance value 180. For example, fan 160 may have different motor properties than fan 150 and, in this embodiment, each fan may require a different PWM duty cycle to rotate at a particular rotation speed.

Once BIOS 115 generates manual control setting 190, BIOS 115 loads manual control setting 190 into manual controller registers 140. In turn, manual fan controller 130 retrieves manual control setting 190 from manual controller registers 140 at intervals and controls fan 160's rotation speed accordingly (via manual control 195).

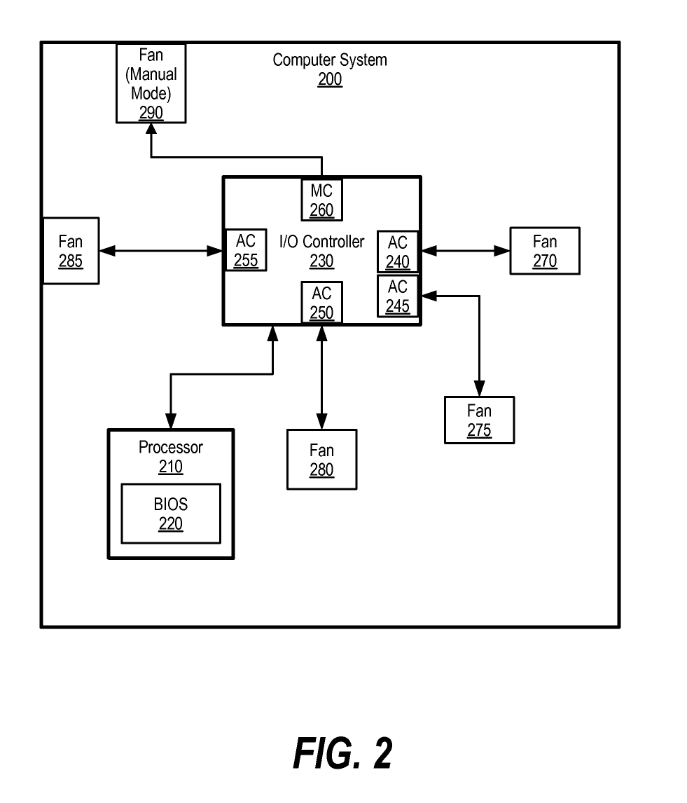

FIG. 2 is a diagram showing another embodiment of a computer system utilizing multiple cooling fans. Similar to FIG. 1, which shows computer system 100 with two fans, FIG. 2 shows computer system 200 with five fans. Computer system 200 includes processor 210, which executes BIOS 220. BIOS 220 loads control settings into I/O controller 230 to control five fans 270, 275, 280, 285, and 290. The embodiment in FIG. 2, however, shows that I/O controller 230 only includes four automatic fan controllers 240, 245, 250, and 255. As such, fan 290 is controlled via manual fan controller 260. For example, fans 285 and 290 may reside on the back and top of computer system 200, respectively, and BIOS 220 may retrieve a performance value corresponding to fan 285 and generate a corresponding control setting for fan 290 in order for fan 285 and fan 290 to rotate at the same rotation speed. As those skilled in the art can appreciate, computer system 200 may include more or less fans than what is shown in FIG. 2.

In one embodiment, BIOS 220 may program I/O controller 230 to generate manual control settings from particular performance values. In this embodiment, BIOS 220 programs I/O controller accordingly and, during real-time operation, I/O controller 230 repetitively retrieves performance values (at intervals) and generates manual control settings without intervention from BIOS 220.

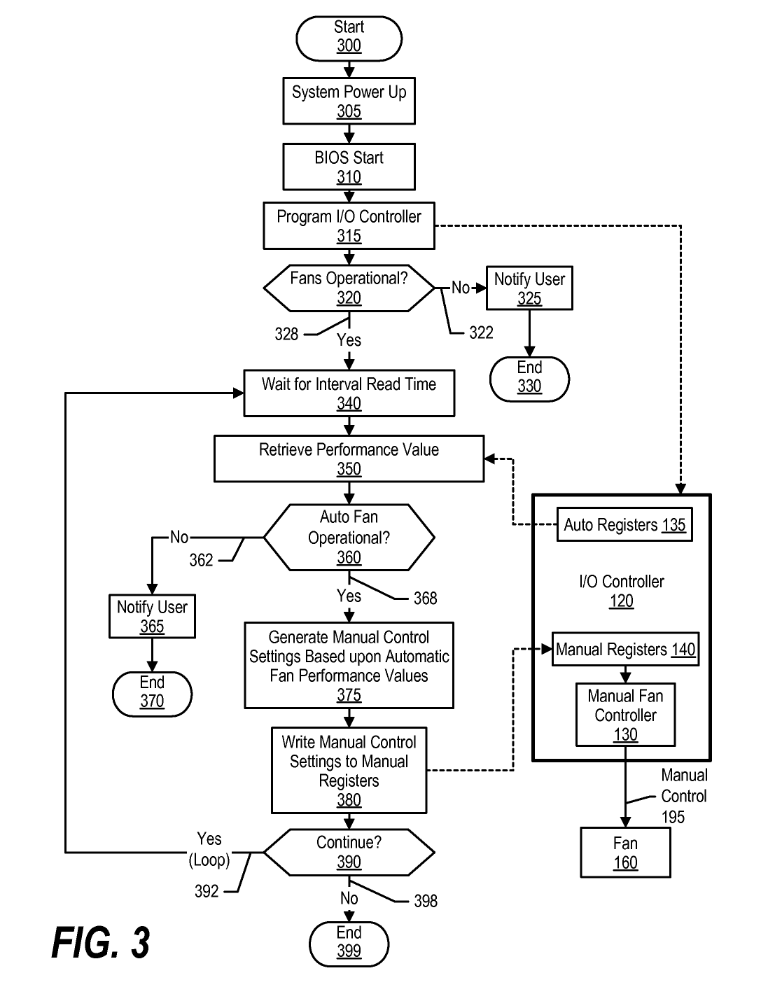

FIG. 3 is a flowchart and hardware diagram showing steps taken in one embodiment of a computer system managing automatic fan controllers and manual fan controllers, such as computer system 100 and/or computer system 200 shown in FIGS. 1 and 2, respectively. After reading this detail description, it will be appreciated by those skilled in the art that other embodiments may be employed to manage automatic fan controllers and manual fan controllers.

Processing commences at 300, whereupon the computer system powers up (step 305) and commences BIOS execution (step 310). At step 315, the BIOS programs I/O controller 120, such as setting automatic control settings for each automatic fan controller. A determination is made as to whether the computer system's fans are operational, such as by monitoring a tachometer value to ensure the value is non-zero (decision 320). If the computer system's fans are not operational, decision 320 branches to “No” branch 322, whereupon processing notifies a user at step 325 (e.g., to prevent overheating), and processing ends at 330.

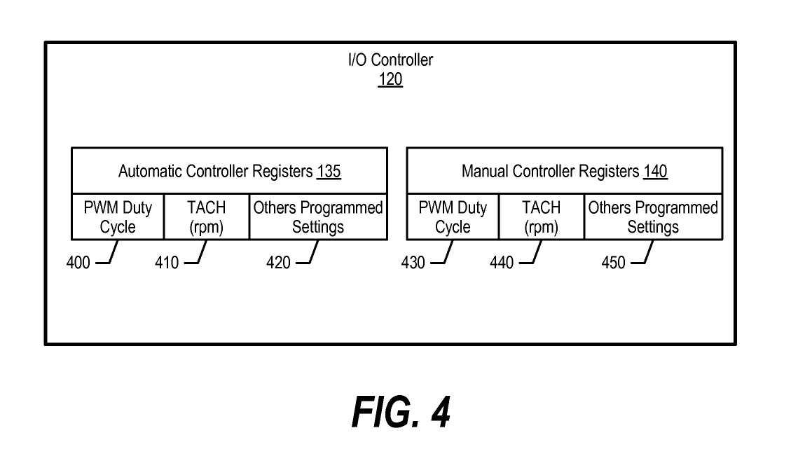

On the other hand, if the computer system's fans are operational, decision 320 branches to “Yes” branch 328, whereupon the BIOS waits for an interval read time to read a performance value from automatic controller registers 135 at step 340 (e.g., every second). At the interval read time, the BIOS retrieves a performance value from automatic controller registers 135 at step 350. For example the performance value may be a PWM duty cycle or a tachometer value (see FIG. 4 and corresponding text for further details).

A determination is made as to whether the automatically controlled fan is operational based upon the performance value (decision 360). For example, if the automatically controlled fan should be rotating at 300 RPM and the performance value is 10 RPM, then the automatically controlled fan is malfunctioning. If the automatically controlled fan is inoperable, decision 360 branches to “No” branch 362, whereupon processing notifies the user at step 365, and processing ends at 370.

On the other hand, of the automatically controlled fan is operational, decision 360 branches to “Yes” branch 368, whereupon the BIOS generates a manual control setting based upon the retrieved performance value (step 375). In one embodiment, the BIOS utilizes the performance value as the manual control setting (same value). In another embodiment, the BIOS utilizes an algorithm to generate the manual control setting from the performance value, such as multiplying the performance value by a constant to derive the manual control setting.

At step 380, the BIOS writes the manual control setting into manual controller registers 140. In turn, manual fan controller 130 retrieves the manual control settings at intervals and controls fan 160's rotation speed through manual control 195 based upon the retrieved control settings, such as multiplying the performance value by a constant.

A determination is made as to whether to continue controlling the computer system's fans (decision 390) (e.g., until the computer system shuts down). If processing should continue controlling the computer system's fans, decision 390 branches to “Yes” branch 392, which loops back to wait for the next interval read time. This looping continues until processing should no longer control the computer system's fans, at which point decision 390 branches to “No” branch 398, whereupon processing ends at 399. In alternative embodiments, processing may perform steps in a different order than what is shown in FIG. 3.

FIG. 4 is diagram showing automatic controller registers and manual controller registers that are included in an input/output controller. I/O controller 120 includes automatic controller registers 135 and manual controller registers 140. An automatic fan controller 125 (FIG. 1) stores performance value(s) in automatic controller registers 135, and a manual fan controller 130 (FIG. 1) retrieves manual control setting(s) from manual controller registers 140.

Automatic controller registers 135 includes registers 400, 410, and 420. During power-up, a BIOS may load automatic control settings into registers 400, 410 in order to configure an automatic fan controller. Register 400 includes a pulse width modulation (PWM) duty cycle performance value. Using a PWM mechanism to supply power to a fan may be an efficient way of providing variable amounts of electrical power to a fan (instead of fully on or fully off). During real-time operation, an automatic fan controller may read a fan's PWM duty cycle and store the value in register 400. Register 410 includes a tachometer value, which is the number of revolutions per minute (RPM) with which the automatically controlled fan rotates. Again, during real-time operation, the automatic fan controller may read a fan's revolutions per minute and store the value in register 410. Register 420 includes other programmed settings, such as a voltage control duty cycle.

Manual controller registers 140 includes registers 430, 440, and 450. Register 430 includes a location for the BIOS to store a pulse width modulation (PWM) duty cycle control setting, which a manual fan controller retrieves and controls a fan accordingly. For example, the PWM duty cycle may be a byte representation of a 50% duty cycle and, in this example, the manual fan controller sets the fan to rotate at 50% of full speed. Register 440 includes a location for the BIOS to store a tachometer control setting, which is the number of revolutions per minute (RPM) that the manual fan controller subsequently programs the fan to rotate. Register 450 includes other programmed settings, such as a voltage control duty cycle.

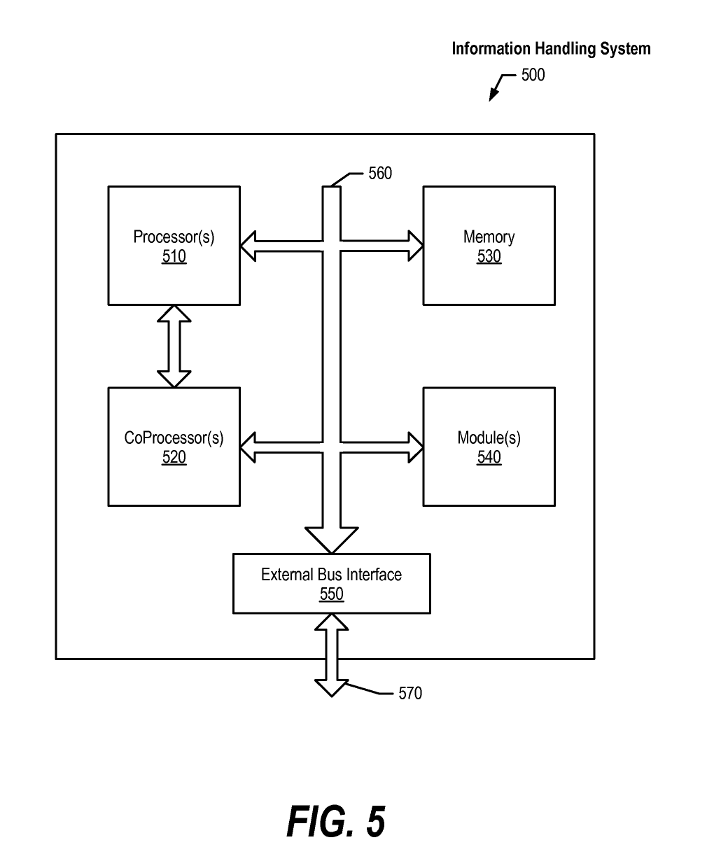

FIG. 5 illustrates information handling system 500, which is another simplified example of a computer system capable of performing the computing operations described herein. Information handling system 500 includes processor(s) 510, co-processor(s) 520, memory 530, module(s) 540, and external bus interface 550, which are all bi-directionally coupled by way of bus 560. Information handling system 500 may couple to external systems by way of external bus 570, such as a USB bus, an Ethernet bus, and so forth. Information handling system 500 also includes multiple fans, such as those shown in FIGS. 1 and 2.

While FIG. 5 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
retrieving a performance value that corresponds to performance of a first fan that is controlled by a first fan controller;
generating a control setting based upon the retrieved performance value; and
controlling, by a second fan controller, a second fan based upon the generated control setting.

2. The method of claim 1 wherein the first fan controller is an automatic fan controller and the second fan controller is a manual fan controller, the method further comprising:
sending automatic control settings to the automatic fan controller;
invoking, by the automatic fan controller, the first fan to rotate based upon the automatic control settings;
after the invoking, receiving the performance value from the first fan; and
storing, by the automatic fan controller, the performance value in an automatic controller register.

3. The method of claim 2 wherein:
the automatic fan controller controls a rotation speed of the first fan; and
the performance value corresponds to the rotation speed of the first fan.

4. The method of claim 3 wherein the control setting corresponds to a rotation speed of the second fan, the method further comprising:
adjusting, by the manual fan controller, the rotation speed of the second fan based upon the control setting, wherein the rotation speed of the first fan matches the rotation speed of the second fan.

5. The method of claim 4, wherein:
the automatic fan controller and the manual fan controller are both located in an input/output controller; and
a BIOS, executed by a processor, performs the generating of the control setting.

6. The method of claim 4 further comprising:
repetitively retrieving, during real-time operation of the first fan, subsequent performance values and generating subsequent control settings; and
providing the subsequent control settings to the manual fan controller to repetitively adjust the rotation speed of the second fan.

7. The method of claim 1 further comprising:
determining whether the first fan is inoperable based upon the performance value; and
notifying a user when the determining step determines that the first fan is inoperable.

8. An information handling system comprising:
one or more processors;
a first fan controller accessible by one or more of the processors;
a second fan controller accessible by one or more of the processors;
a first fan that is controlled by the first fan controller;
a second fan that is controlled by the second fan controller;
a memory accessible by at least one of the processors;
a set of instructions stored in the memory and executed by at least one of the processors in order to perform actions of:
retrieving a performance value that corresponds to performance of the first fan;
generating a control setting based upon the retrieved performance value; and
controlling the second fan based upon the generated control setting.

9. The information handling system of claim 8 wherein the first fan controller is an automatic fan controller and the second fan controller is a manual fan controller, and wherein the set of instructions, when executed by at least one of the processors, further performs actions of:
sending automatic control settings to the automatic fan controller;
invoking the first fan to rotate based upon the automatic control settings;
after the invoking, receiving the performance value from the first fan; and
storing, by the automatic fan controller, the performance value in an automatic controller register

10. The information handling system of claim 9 wherein:
the automatic fan controller controls a rotation speed of the first fan; and
the performance value corresponds to the rotation speed of the first fan.

11. The information handling system of claim 10 wherein the control setting corresponds to a rotation speed of the second fan, and wherein the set of instructions, when executed by at least one of the processors, further performs actions of:
adjusting, by the manual fan controller, the rotation speed of the second fan based upon the control setting, wherein the rotation speed of the first fan matches the rotation speed of the second fan.

12. The information handling system of claim 11 wherein:
the automatic fan controller and the manual fan controller are both located in an input/output controller; and
a BIOS, executed by one of the processors, performs the generating of the control setting.

13. The information handling system of claim 11 wherein the set of instructions, when executed by at least one of the processors, further performs actions of:
repetitively retrieving, during real-time operation of the first fan, subsequent performance values and generating subsequent control settings; and
providing the subsequent control settings to the manual fan controller to repetitively adjust the rotation speed of the second fan.

14. The information handling system of claim 8 wherein the set of instructions, when executed by at least one of the processors, further performs actions of:
determining whether the first fan is inoperable based upon the performance value; and
notifying a user when the determining step determines that the first fan is inoperable.

15. A computer program product stored in a computer readable medium, comprising functional descriptive material that, when executed by an information handling system, causes the information handling system to perform actions that include:
retrieving a performance value that corresponds to performance of a first fan that is controlled by a first fan controller;
generating a control setting based upon the retrieved performance value; and
controlling, by a second fan controller, a second fan based upon the generated control setting.

16. The computer program product of claim 15 wherein the first fan controller is an automatic fan controller and the second fan controller is a manual fan controller, and wherein the functional descriptive material, when executed by the information handling system, causes the information handling system to further perform actions of:
sending automatic control settings to the automatic fan controller;
invoking the first fan to rotate based upon the automatic control settings;
after the invoking, receiving the performance value from the first fan; and
storing, by the automatic fan controller, the performance value in an automatic controller register.

17. The computer program product of claim 16 wherein:
the automatic fan controller controls a rotation speed of the first fan; and
the performance value corresponds to the rotation speed of the first fan.

18. The computer program product of claim 17 wherein the control setting corresponds to a rotation speed of the second fan, and wherein the functional descriptive material, when executed by the information handling system, causes the information handling system to further perform actions of:
adjusting, by the manual fan controller, the rotation speed of the second fan based upon the control setting, wherein the rotation speed of the first fan matches the rotation speed of the second fan.

19. The computer program product of claim 18 wherein:
the automatic fan controller and the manual fan controller are both located in an input/output controller; and
a BIOS, executed by a processor, performs the generating of the control setting.

20. The computer program product of claim 18 wherein the functional descriptive material, when executed by the information handling system, causes the information handling system to further perform actions of:
repetitively retrieving, during real-time operation of the first fan, subsequent performance values and generating subsequent control settings; and
providing the subsequent control settings to the manual fan controller to repetitively adjust the rotation speed of the second fan.
